(19) United States
(12) Patent Application Publication
(10) Pub. No.: US 2025/0122797 A1
(43) Pub. Date: Apr. 17, 2025

(54) BATTERY SAFETY MONITOR

(71) Applicant: Baker Hughes Oilfield Operations LLC, Houston, TX (US)

(72) Inventor: Paul Goud, Calgary (CA)

(21) Appl. No.: 18/487,525

(22) Filed: Oct. 16, 2023

(51) Int. Cl. E21B 47/12; E21B 41/00; H01M 10/42; H01M 10/48

(52) U.S. Cl. CPC E21B 47/12; E21B 41/00; H01M 10/425; H01M 10/48; H01M 10/486; H01M 2010/4278; H01M 2220/10

(57) ABSTRACT

An apparatus collects one or more metrics associated with an energy storage device in response to one or more criteria and transmits the one or more metrics based on a comparison of the one or more metrics to a target threshold value. The one or more metrics include a concentration level of a noxious gas. The apparatus activates one or more functions based on at least one of a control signal and the comparison. The one or more functions include at least one of a first function associated with venting the energy storage device and a second function associated with decoupling the energy storage device from a tool electrically coupled to the energy storage device.

### BACKGROUND

In the resource recovery and fluid sequestration industries, electronic tools may be used to monitor conditions and control or perform operations downhole. Some electronic tools may be powered by non-rechargeable lithium batteries. Techniques for effectively assessing the condition of the batteries are desired.

### SUMMARY

Embodiments of the present disclosure are directed to an apparatus including a processor; and a memory storing instructions thereon that, when executed by the processor, cause the processor to: collect one or more metrics associated with an energy storage device in response to one or more criteria, where the one or more metrics comprise a concentration level of a noxious gas; and transmit the one or more metrics based on a comparison of the one or more metrics to a target threshold value.

Embodiments of the present disclosure are also directed to a system including: an energy storage device, a monitoring device, and a computing device. The monitoring device is configured to: collect one or more metrics associated with the energy storage device in response to one or more criteria, where the one or more metrics include a concentration level of a noxious gas; and transmit the one or more metrics based on a comparison of the one or more metrics to a target threshold value. The computing device is configured to generate one or more notifications based on the one or more metrics.

Embodiments of the present disclosure are also directed to a computer-implemented method including: collecting one or more metrics associated with an energy storage device in response to one or more criteria, where the one or more metrics include a concentration level of a noxious gas; and electronically transmitting the one or more metrics based on a comparison of the one or more metrics to a target threshold value.

### BRIEF DESCRIPTION OF THE DRAWINGS

The following descriptions should not be considered limiting in any way. With reference to the accompanying drawings, like elements are numbered alike:

FIG. 1 is a diagram illustrating an example embodiment of a system 100 for performing energy industry operations and battery monitoring in accordance with aspects of the present disclosure.

FIG. 2 is a block diagram illustrating an example embodiment of a battery monitoring network in accordance with aspects of the present disclosure.

FIG. 3 is a block diagram illustrating an example embodiment of a monitoring device in accordance with aspects of the present disclosure.

FIG. 4 illustrates an example flowchart of a method in accordance with one or more embodiments of the present disclosure.

FIG. 5 illustrates an example flowchart of a method in accordance with one or more embodiments of the present disclosure.

### DETAILED DESCRIPTION

A detailed description of one or more embodiments of the disclosed apparatus and method are presented herein by way of exemplification and not limitation with reference to the Figures.

For electronic tools powered by non-rechargeable batteries (e.g., non-rechargeable lithium batteries), the batteries can become hazardous when damaged, overheated, or discharged. For example, a battery may be damaged due to being dropped or due to mechanical shock during transportation.

An example hazard associated with disposable lithium batteries is the possibility of severe respiratory effects or death due to leakage of a noxious gas from the batteries. For example, sulfur dioxide gas is a gaseous byproduct that accumulates internally in a lithium battery. If the gas escapes, the gas can cause severe respiratory injury to individuals relatively near to the battery.

Other example hazards associated with disposable lithium batteries include the possibility of severe injury or death due to explosion of a battery. For example, lithium melts at a temperature above 180.5 degrees Celsius. If the metal in a battery begins to melt due to temperature (e.g., due to relatively high temperatures downhole), the metal may react violently with the electrolyte in the battery and result in an explosion. In another example, damage to a battery due to droppage of the battery or mechanical shock to the battery can result in an internal short-circuit, which may result in overheating and an explosion.

Some procedures for assessing the condition of a battery and/or the risk associated with using the battery (e.g., risk of explosion, risk of sulfur dioxide gas leak, or the like) are manually performed, time-consuming, vulnerable to imprecise measurements due to operator error, and vulnerable to injury of the operator. For example, some battery emergency response procedures include an operator making subjective measurements of the state of a battery through manual examination of the battery for discoloration and manual temperature checking. In the case of gas leakage or explosion, such manual assessment places the operator at risk of injury or death.

In addition, at a rig site, conditions may not allow for a large amount of time or a suitable location for assessment of the health of a battery.

According to one or more embodiments of the present disclosure, techniques and a monitoring device are described which support the use of internal measurements (e.g., internal measurements of a battery compartment, measurements of the battery compartment while the battery is downhole, or the like), enabling increased speed and accuracy in association with the assessment of the state or health of the battery. In one or more embodiments, the techniques and monitoring device described herein support remote delivery of the measurements from the monitoring device to a user computing device located above surface, enabling the user to conduct an assessment of a battery suspected of a problem (e.g., potential for explosion, potential for gas leakage, or the like) at a safe distance and avoid potential injury. The techniques support increased speed and safety for assessing a battery after an event occurs (e.g., the battery is dropped, mechanically or electrically shocked, or the like).

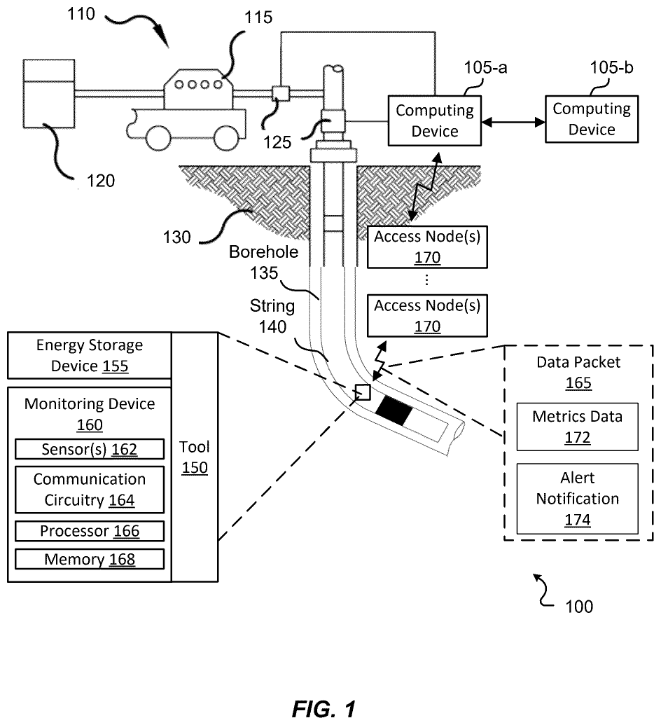

FIG. 1 is a diagram illustrating an example embodiment of a system 100 for performing energy industry operations and battery monitoring in accordance with aspects of the present disclosure.

The system 100 is configured to perform any suitable energy industry operation, such as, for example, a drilling operation, a stimulation operation, a measurement operation and/or a production operation.

The system 100 includes a borehole 135 in a subsurface formation 130. A borehole string 140 (also referred to herein as a drill string) is disposed in the borehole 135 that penetrates the formation 130. The borehole 135 may be an open hole, a cased hole or a partially cased hole. In one embodiment, the borehole string 140 is a stimulation or injection string that includes a tubular, such as a coiled tubing, pipe (e.g., multiple pipe segments) or wired pipe, that extends from a wellhead at a surface location (e.g., at a drill site or offshore stimulation vessel).

As described herein, a “string” refers to any structure or carrier suitable for lowering a tool or other component through a borehole or connecting a drill bit to the surface, and is not limited to the structure and configuration described herein. The term “carrier” as used herein means any device, device component, combination of devices, media and/or member that may be used to convey, house, support or otherwise facilitate the use of another device, device component, combination of devices, media and/or member. Example non-limiting carriers include casing pipes, wirelines, wireline sondes, slickline sondes, drop shots, downhole subs, BHAs and drill strings.

In one embodiment, the system 100 is configured as a hydraulic stimulation system. As described herein, “hydraulic stimulation” includes any injection of a fluid into a formation. A fluid may be any flowable substance such as a liquid or a gas, and/or a flowable solid such as sand. In this embodiment, the borehole string 140 includes a stimulation assembly that includes one or more tools 150 or components to facilitate stimulation of the formation 130. Non-limiting examples of the tools 150 included in the borehole string 140 include a fracturing assembly (e.g., a fracture or “frac” sleeve device), a perforation assembly (e.g., shaped charges, torches, projectiles and other devices for perforating the borehole wall and/or casing), and isolation or packer subs.

One or more of the tools 150 may include suitable electronics or processors configured to communicate with a surface processing unit (e.g., a computing device 105) and/or control the respective tool 150 or assembly.

The system 100 includes surface equipment 110 for performing various energy industry operations. For example, the surface equipment 110 is configured for injection of fluids into the borehole 135 in order to, e.g., fracture the formation 130. In one or more embodiments, the surface equipment 110 includes an injection device such as a high pressure pump 115 in fluid communication with a fluid tank 120, mixing unit or other fluid source or combination of fluid sources. The pump 115 injects fluid into the borehole string 140 or the borehole 135 to introduce fluid into the formation 130, for example, to stimulate and/or fracture the formation 130. The pump 115 may be located downhole or at a surface location.

One or more flow rate and/or pressure sensors 125 may be disposed in fluid communication with the pump 115 and the borehole string 140 for measurement of fluid characteristics. The sensors 125 may be positioned at any suitable location, such as proximate to (e.g., at the discharge output) or within the pump 115, at or near the wellhead, or at any other location along the borehole string 140 or the borehole 135. The sensors described herein are exemplary, as various types of sensors may be used to measure various parameters.

A computing device 105 (e.g., computing device 105-a) may be disposed in operable communication with components such as sensors 125 located above the surface, the pump 115, and/or downhole components. For example, the computing device 105 may be in operable communication with sensors 162 (e.g., pressure sensors, temperature sensors, vibration sensors, gas sensors, and the like) located below the surface and/or in the borehole string 140. In some examples, the computing device 105-a may be in operable communication with a tool 150 (or multiple tools) and/or a monitoring device 160 (or multiple monitoring devices).

The system 100 supports communication between the computing device 105 and other devices of the system 100 via wired communication protocols, wireless communication protocols (e.g., electromagnetic (EM) signals, WiFi, Bluetooth™, ZigBee™M, Ubiquiti™, 3G, 4G, LTE, and the like), and/or combinations including one or more of the foregoing.

The system 100 supports telemetry techniques capable of transmitting data from components located downhole to the surface and/or surface equipment 110. Non-limiting examples of the telemetry techniques include acoustic telemetry or mud pulse (MP) telemetry supportive of transmitting information by generating vibrations in fluid in the borehole 135, electromagnetic (EM) telemetry supportive of transmitting information by way of signals that propagate at least in part through the earth (e.g., through formations 130). Other non-limiting examples of telemetry techniques supported by aspects of the present disclosure include the use of hardwired drill pipe, fibre optic cable, or drill collar acoustic telemetry to carry data to the surface and/or surface equipment 110.

The system 100 may include one or more access nodes 170 supportive of communicating data along the borehole string 140 (e.g., up or down the borehole string 140). In one or more embodiments, the access nodes 170 may be implemented in the borehole 135 or a communication borehole (not illustrated) separate from the borehole 135. In some examples, the one or more access nodes 170 may provide functionality as wireless access nodes for relaying data from a tool 150 to the surface (e.g., to a computing device 105).

In one or more embodiments, the system 100 may include a chain of access nodes 170 spaced apart along the borehole string 140, and the chain of access nodes 170 may support repeating of data in a unidirectional (e.g. downhole to surface or surface to downhole) or bidirectional manner. For example, an access node 170 (or chain of access nodes 170) may support the communication of data between a computing device 105, a tool 150, a monitoring device 160, and the like.

Accordingly, for example, the communication protocols and telemetry techniques supported by the system 100 enable communication between computing devices 105 (e.g., computing device 105-a, computing device 105-b, and the like) and downhole components.

The computing device 105 is configured to receive, store and/or transmit data generated from components (e.g., pump 115, fluid tank 120, sensors 125, and the like) included in the surface equipment 110 and/or downhole components (e.g., a tool 150, an energy storage device 155, a monitoring device 160, sensors 162, and the like). The computing device 105 includes processing components configured to analyze received data (e.g., data received from the pump 115, fluid tank 120, sensors 125, a tool 150, an energy storage device 155, a monitoring device 160, and the like). The computing device 105 includes processing components configured to provide data (e.g., alerts, data analysis results, and the like) and/or control signals (e.g., operational parameters) to other components of the system 100. The computing device 105 includes any number of suitable components, such as processors, memory, communication devices and power sources.

According to one or more embodiments of the present disclosure, techniques are described that support safety monitoring of an energy storage device 155 (e.g., a lithium battery). The techniques may be implemented by a monitoring device 160 as described herein. Additionally, or alternatively, the techniques may be implemented by a computing device 105 in response to processing data provided by the monitoring device 160.

In an example, a tool 150 may be electrically coupled to and powered by energy storage device 155. In some aspects, the energy storage device 155 may be included in a housing separate from or integrated with the tool 150. The energy storage device 155, may be, for example, a lithium battery but is not limited thereto.

The monitoring device 160 may be included in a housing separate from or integrated with the tool 150. In some aspects, the monitoring device 160 may be mechanically or electrically coupled to the tool 150. The monitoring device 160 may include or be electrically coupled to one or more sensors 162, and the one or more sensors 162 are capable of providing data (e.g., metrics described herein) associated with the energy storage device 155 and/or the tool 150 to the monitoring device 160.

The monitoring device 160 includes communication circuitry 164 supportive of transmitting and receiving data in accordance with communication protocols and telemetry techniques described herein. The monitoring device 160 includes a processor 166 capable of performing one or more functions of the monitoring device 160 in response to executing data (e.g., executable instructions) stored on a memory 168 of the monitoring device 160. In some examples, the processor 166 may be a microprocessor. The memory 168 may include any suitable combination of volatile and/or non-volatile memory supportive of the functions described herein of the monitoring device 160. In some examples, the memory 168 may include a flash memory.

Non-limiting examples of functions performable by the monitoring device 160 include enabling an active state or a sleep state of the processor 166, collection of data (e.g., metrics) associated with the energy storage device 155 as provided by one or more sensors 162, analysis of the data (e.g., comparison metrics to a target threshold value), and transmitting the data (e.g., metrics) to a computing device 105 based on the analysis.

According to example aspects of the present disclosure, the monitoring device 160 may collect metrics associated with an energy storage device 155 in response to criteria such as, for example, a temporal threshold. Additionally, or alternatively, the criteria may include the detection of a motion event associated with the energy storage device 155 and/or the tool 150 (e.g., the energy storage device 155 or the tool 150 is dropped, a collision event associated with the energy storage device 155 or the tool 150, or the like). Additionally, or alternatively, the criteria may include the detection of a shock event (e.g., an electrical shock, a spike in voltage, or the like) associated with the energy storage device 155 and/or the tool 150.

In some examples, the metrics include a concentration level of a noxious gas (e.g., a sulfur oxide, sulfur dioxide, or the like). Other non-limiting examples of the metrics include an internal pressure measurement value (e.g., battery compartment pressure) associated with the energy storage device 155, a temperature measurement value associated with the energy storage device 155, an electrical shock measurement value associated with the energy storage device 155 and/or the tool 150, and a vibration measurement value associated with the energy storage device 155 and/or the tool 150. Other non-limiting examples of the metrics include a rotation speed measurement value associated with the energy storage device 155 and/or a bending measurement value associated with the energy storage device 155. For example, the centrifugal force from an excessive RPM may damage the energy storage device 155.

The monitoring device 160 may generate and transmit, using communication circuitry 164, a data packet 165 including metrics data 172 (including the metrics) based on a comparison of the metrics to a target threshold value (e.g., a target concentration level of the noxious gas). In one or more embodiments, the monitoring device 160 may generate and transmit an alert notification 174 based on the comparison (e.g., for cases in which the metrics exceed the target threshold value, for cases in which the metrics are trending closer to the target threshold value with respect to time, and the like).

In an example, the monitoring device 160 may transmit the data packet 165 via one or more access nodes 170 to a computing device 105. Additionally, or alternatively, the monitoring device 160 may transmit the data packet 165 via any suitable communication protocol or telemetry technique described herein.

In one or more embodiments, the computing device 105 may generate a notification (e.g., an alert) or reporting data associated with the energy storage device 155 based on analyzing the metrics data 172 (including the metrics). Additionally, or alternatively, the computing device 105 may output the alert notification 174 provided by the monitoring device 160.

The monitoring device 160 may support remote operations based on control signals or control messages transmitted by the computing device 105. Example aspects of establishing a remote connection between the monitoring device 160 and the computing device 105 in association with implementing the remote operations are later described herein.

The monitoring device 160 may autonomously implement one or more safety functions for cases in which a measured metric (e.g., concentration level of a noxious gas, temperature of the energy storage device 155, or the like) exceeds a respective threshold value. Additionally, or alternatively, the monitoring device 160 may implement the one or more safety functions in response to a control signal or control message from the computing device 105. Non-limiting examples of the safety functions include a first function of venting the energy storage device 155 and a second function of electrically and/or physically decoupling the energy storage device 155 from the tool 150.

Additional example and/or alternative aspects of the monitoring device 160 will further be described with reference to the following figures.

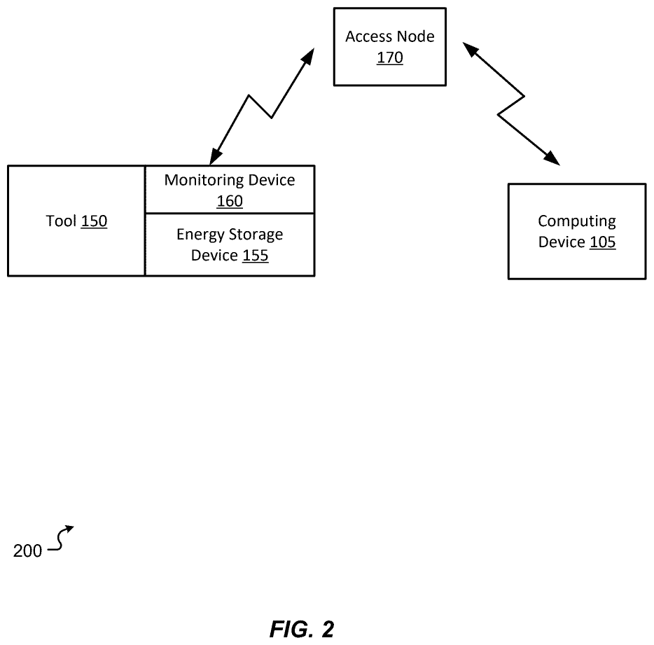

FIG. 2 is a block diagram illustrating an example embodiment of a battery monitoring network 200 in accordance with aspects of the present disclosure. The battery monitoring network may include a tool 150 (e.g., a downhole tool), an energy storage device 155, a monitoring device 160, an access node 170, and a computing device 105. The tool 150, the monitoring device 160, the access nodes 170, and the computing device 105 may exchange data over the network using communication protocols and/or telemetry protocols described herein. Repeated descriptions of elements as described at FIGS. 1 and 2 are omitted for brevity.

In a non-limiting example described with reference to FIG. 2, the energy storage device 155 is a lithium battery, the monitoring device 160 is a monitor card capable of wireless communications (e.g., using communication circuitry 164 of FIG. 1), the access node 170 is a WiFi access point, and the computing device 105 is a laptop computer including a network interface supportive of wireless communications with the access node 170. The tool 150 may include a battery section or battery compartment for housing the energy storage device 155.

However, aspects of the present disclosure are not limited to the example of FIG. 2, and the system 100 of FIG. 1 supports various suitable modes of communication (e.g., wired communication, wireless communication, telemetry techniques, and the like), various instances of access nodes 170 (e.g., a single access node 170, multiple access nodes 170), monitoring of various battery types, and various implementations of a monitoring device 160 (e.g., a monitor card, monitoring circuitry, and the like) supportive of battery monitoring techniques are described herein.

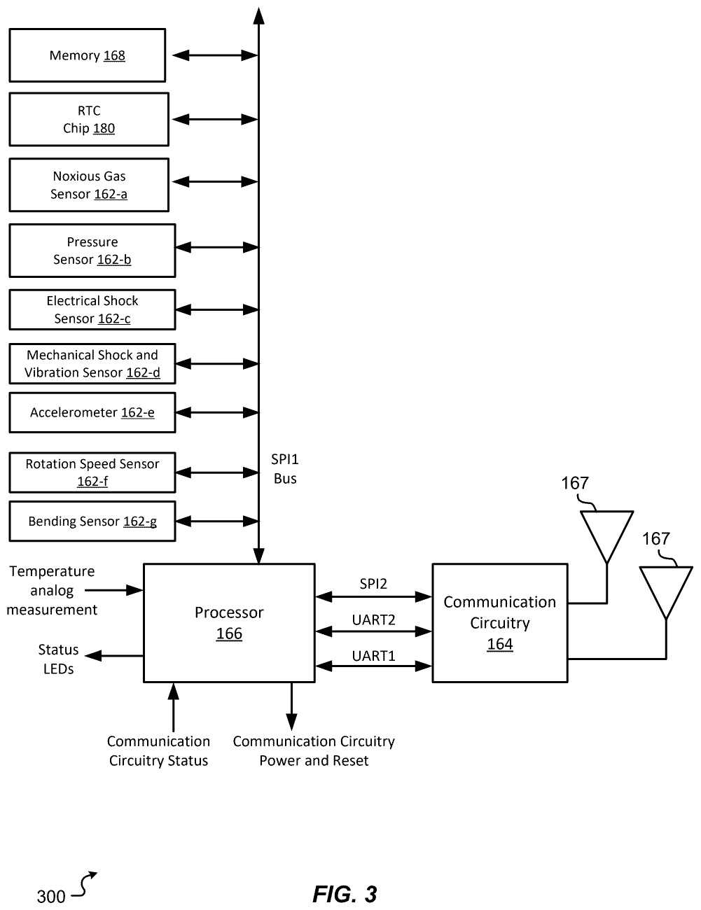

FIG. 3 is a block diagram 300 illustrating an example embodiment of the monitoring device 160 of FIGS. 1 and 2 in accordance with aspects of the present disclosure. Repeated descriptions of elements of the monitoring device 160 as described at FIGS. 1 and 2 are omitted for brevity.

The monitoring device 160 may further include a real-time clock (RTC) chip 180. The RTC chip 180 is an electronic device such as, for example, an integrated circuit (IC), which keeps track of the current time and maintains accurate time (e.g., passage of time). In some aspects, the RTC chip 180 may include a power source different from a primary power source of the monitoring device 160, such that the RTC chip 180 can continue to keep time if the primary power source is off or becomes unavailable. The RTC chip 180 may include a battery switch-over circuit (not illustrated) capable of detecting when the primary power source is unavailable and automatically switching to the power source of the RTC chip 180. The RTC chip 180 is capable of providing timestamps that may be inserted into records of measurements that are stored to the memory 168. The records can be uploaded and analyzed (e.g., by computing device 105) to determine culpability for damage to an energy storage device 155.

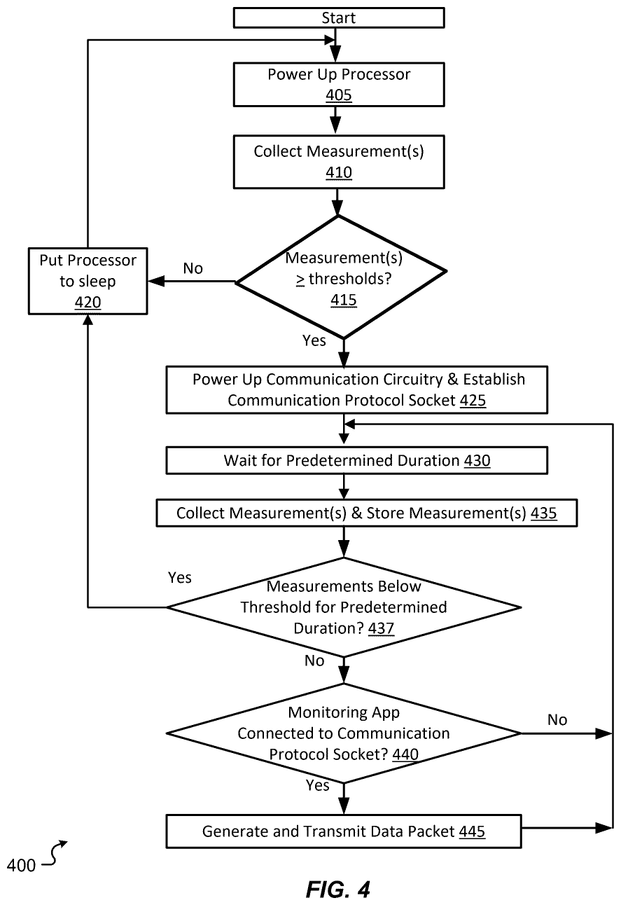

The sensors 162 included in the monitoring device 160 may include a noxious gas sensor 162-a, a pressure sensor 162-b, an electrical shock sensor 162-c, a mechanical shock and vibration sensor 162-d, an accelerometer 162-e (also referred to herein as an acceleration sensor), a rotation speed sensor 162-f (e.g., RPM sensor), and a bending sensor 162-g, example aspects of which are described herein. Each sensor 162 (e.g., noxious gas sensor 162-a, pressure sensor 162-b) may be capable of providing a wakeup signal associated with powering the processor 166 in response to an event, example aspects of which are later described with reference to FIG. 4.

The processor 166 is capable of receiving temperature analog measurements from a temperature sensor (not illustrated) of the monitoring device 160. The temperature analog measurements may be of energy storage device 155 and/or of the environment within a region in which the monitoring device 160 is located. The processor 166 is capable of providing output signals indicating one or more statuses of the monitoring device 160, to status LEDs (not illustrated) of the monitoring device 160.

The processor 166 is capable of transmitting and receiving signals associated with the communication circuitry 164. For example, the processor 166 may receive a status signal (WiFi status) from communication circuitry 164 indicating a corresponding status (e.g., enabled/awake, disabled/asleep) of the communication circuitry 164. The processor 166 may transmit signals to the communication circuitry 164 in association with powering on or resetting the communication circuitry 164.

In some examples, the communication circuitry 164 may be a WiFi module, but is not limited thereto. For example, the communication circuitry 164 may be a communication module supportive of a suitable communication protocol or telemetry technique described herein. The communication circuitry 164 may include antennas 167 supportive of wireless communication protocols described herein.

The monitoring device 160 may include data buses (e.g., Serial Peripheral Interface (SPI) busses, for example, SPI1 and SPI2) supportive of communications between the processor 166 and other components of the monitoring device 160.

The monitoring device 160 may include universal asynchronous receiver/transmitter (UART) wires UART1 and UART2 supportive of transmitting and receiving serial data between processor 166 and communication circuitry 164.

Though not illustrated, the monitoring device 160 may be powered by a battery included in or electrically coupled to the monitoring device 160. In an example implementation, the battery powering the monitoring device 160 may be a rechargeable lithium-ion battery. In some cases, the battery (e.g., lithium-ion battery) associated with powering the monitoring device 160 may be different from and relatively safer than the energy storage device 155 (e.g., lithium metal battery) powering the tool 150 because [˜] the lithium in lithium metal batteries is in a more reactive form than the lithium found in lithium-ion batteries. Also, chemicals (e.g. thionyl chloride) found in lithium metal batteries (and not found in lithium-ion batteries) can create harmful vapors.

FIG. 4 illustrates an example flowchart of a method 400 in accordance with one or more embodiments of the present disclosure. The method 400 may be implemented by the example aspects of a monitoring device 160 (and/or a computing device 105) as described herein.

At 405, the method 400 includes powering up the processor 166. For example, at 405, the monitoring device 160 may provide power to the processor 166 for collecting one or more measurements from one or more sensors 162.

In one or more embodiments, the monitoring device 160 may provide power to the processor 166 based on a temporal threshold (e.g., every 1 minute, every 2 minutes, or the like). In some examples, the monitoring device 160 may provide power to the processor 166 in response to receiving a wakeup signal from a low power timer circuit (not illustrated) that retains power while the processor 166 is asleep. In some examples, the low power timer circuit may provide the wakeup signal according to a predetermined interval (e.g., 1 minute, 2 minutes, or the like).

In one or more other embodiments, the monitoring device 160 may provide power to the processor 166 in response to an event. For example, the monitoring device 160 may provide power to the processor 166 in response to receiving a wakeup signal from electrical shock sensor 162-c (e.g., in response to a detected shock by the electrical shock sensor 162-c), receiving a wakeup signal from mechanical shock and vibration sensor 162-d (e.g., in response to a detected mechanical shock or vibration by the mechanical shock and vibration sensor 162-d), or the like.

At 410, the method 400 includes collecting the measurements. In an example, at 410, the method 400 includes persisting collected measurements to the memory 168.

The measurements may include, for example, any suitable combination of a concentration level of a noxious gas (e.g., a sulfur oxide, sulfur dioxide, or the like), internal pressure measurement value (e.g., battery compartment pressure) associated with the energy storage device 155, a temperature measurement value associated with the energy storage device 155, an electrical shock measurement value associated with the energy storage device 155 and/or the tool 150, a vibration measurement value associated with the energy storage device 155 and/or the tool 150, a rotation speed measurement associated with the energy storage device 155, and/or a bending measurement associated with the energy storage device 155, but is not limited thereto.

At 415, the method 400 includes comparing the measurements to respective threshold values.

In an example, in response to determining the measurements are not greater than or equal to the respective threshold values (‘No’), the method 400 includes proceeding to 420. At 420, method 400 includes putting the processor to sleep (e.g., activating a sleep state of the processor 166).

In another example, in response to determining the measurements are greater than or equal to the respective threshold values (‘Yes’), the method 400 includes proceeding to 425.

According to one or more embodiments of the present disclosure, the determination at 415 may be based on a single measurement or any suitable combination of measurements. In an example implementation, the method 400 includes proceeding to 425 in response to determining that a target measurement (e.g., concentration level of noxious gas) is greater than or equal to a respective threshold value. In another example implementation, the method 400 includes proceeding to 425 in response to determining that the target measurement and at least one other measurement (e.g., internal pressure or temperature associated with the energy storage device 155) are greater than or equal to respective threshold values. In some other example implementations, the method 400 includes proceeding to 425 in response to determining that all measurements are greater than or equal to respective threshold values.

At 425, the method 400 includes powering up communication circuitry 164. In some aspects, at 425, the method 400 includes establishing a communication protocol socket (e.g., a Transmission Control Protocol (TCP)/Internet Protocol (IP) socket) for facilitating communication between monitoring device 160 (and communication circuitry 164) and computing device 105. In an example, the communication protocol socket may be a listening communication protocol socket supportive of listening to applications or processes on the network.

The communication protocol socket supports establishing a remote connection to the monitoring device 160 and a monitoring application executed at the computing device 105. In an example, the application may support control of the monitoring device 160 by the computing device 105 and the transfer of data between the monitoring device 160 and the computing device 105.

Accordingly, for example, by separately powering on the processor 166 and the communication circuitry 164 in response to corresponding criteria, the method 400 supports saving battery charge of the battery which powers the monitoring device 160.

At 430, the method 400 includes waiting for a predetermined temporal duration. In an example, the predetermined temporal duration may be equal to 10 seconds, but is not limited thereto. For example, the temporal duration may be a predetermined amount of time associated with how frequently the measurement updates are to be provided. In some cases, the amount of time for the processor 166 to retrieve a measurement from an external sensor may be about a few milliseconds or less.

At 435, the method 400 includes collecting one or more measurements and storing (persisting) the one or more measurements to the memory 168.

In some aspects, at 435, the method 400 may include storing the target measurement (e.g., concentration level of noxious gas) to the memory 168, storing the target measurement and at least one other measurement (e.g., internal pressure or temperature associated with the energy storage device 155), or storing all measurements to the memory 168. In some aspects, at 435, the method 400 may include storing an RTC timestamp along with the target measurements in a record to the memory 168. The records can later be uploaded (e.g., as described with reference to 445) and analyzed to determine the timing (and culpability) of damage events to the energy storage device 155.

At 440, the method 400 includes determining whether the monitoring application is connected to the communication protocol socket. In an example, in response to determining the monitoring application is connected to the communication protocol socket (‘Yes’), the method 400 includes proceeding to 445. In another example, in response to determining the monitoring application is not connected to the communication protocol socket (‘No’), the method 400 includes returning to 430.

At 445, the method 400 includes generating and transmitting a data packet 165. In an example, the monitoring device 160 may transmit the data packet 165 to the computing device 105 via one or more access nodes 170. In one or more embodiments, the monitoring device 160 may transmit the data packet 165 via any suitable communication protocol or telemetry technique described herein.

In an example implementation, the data packet 165 may include all measurements collected at 435. In some other example implementations, the data packet 165 may include the target measurement (e.g., concentration level of noxious gas), with or without other measurements (e.g., internal pressure of the energy storage device 155, temperature associated with the energy storage device 155, or the like).

The method 400 may include repeating 430 through 445 for one or more iterations. Accordingly, for example, the method 400 supports continuously or semi-continuously providing updated measurement data to computing device 105.

In some aspects, (not illustrated), the method 400 may include returning to 420 and putting the processor 166 to sleep (e.g., activating the sleep state of the processor 166) after 445. In an example, the monitoring device 160 may activate the sleep state in response to receiving a control signal from the computing device 105. In another example, at 437, the method 400 may include determining whether all measurements (or a set of target measurements) have been continuously below their respective thresholds for a predetermined temporal period. If ‘Yes’, the method 400 may include proceeding to 420 and putting the processor 166 to sleep. If ‘No,’ the method 400 may include proceeding to 440.

In another example, the monitoring device 160 may activate the sleep state in response to satisfying one or more other criteria. Non-limiting examples of the criteria include a threshold quantity of measurements, a threshold quantity of transmissions of data packets 165, a temporal threshold, and the activation of a function at the monitoring device 160 (e.g., venting of the energy storage device 155, decoupling of the energy storage device 155 from the tool 150, and the like).

In some aspects, 405 through 415 of the method 400 may be associated with a partially active state of the monitoring device 160, 425 through 445 of the method 400 may be associated with a fully active state of the monitoring device 160, and 420 of the method 400 may be associated with a sleep state of the monitoring device 160.

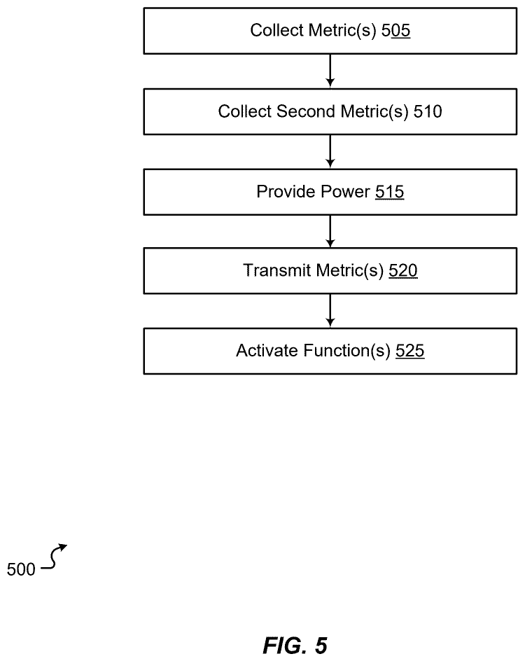

FIG. 5 illustrates an example flowchart of a method 500 in accordance with one or more embodiments of the present disclosure. The method 500 may be implemented by the example aspects of a monitoring device 160 (and/or a computing device 105) as described herein.

At 505, the method 500 includes collecting one or more metrics associated with an energy storage device in response to one or more criteria, where the one or more metrics include a concentration level of a noxious gas.

At 510, the method 500 includes collecting one or more second metrics associated with the energy storage device, a tool electrically coupled to the energy storage device, or both based on comparing the one or more metrics to the target threshold value.

At 515, the method 500 includes providing power in association with transmitting the one or more metrics, based on comparing the one or more metrics to the target threshold value.

At 520, the method 500 includes electronically transmitting the one or more metrics based on a comparison of the one or more metrics to a target threshold value. In some examples, at 520, the method 500 includes electronically transmitting the one or more second metrics.

At 525, the method 500 includes activating one or more functions based on at least one of: one or more control signals; and the comparison of the one or more metrics to the target threshold value. In some aspects, the one or more functions include at least one of: a first function associated with venting the energy storage device; and a second function associated with decoupling the energy storage device from a tool electrically coupled to the energy storage device.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Set forth below are some embodiments of the foregoing disclosure:

Example 1. An apparatus comprising: a processor; and a memory storing instructions thereon that, when executed by the processor, cause the processor to: collect one or more metrics associated with an energy storage device in response to one or more criteria, wherein the one or more metrics comprise a concentration level of a noxious gas; and transmit the one or more metrics based on a comparison of the one or more metrics to a target threshold value.

Example 2. The apparatus of Example 1, wherein the instructions, when executed by the processor, further cause the processor to: collect one or more second metrics associated with the energy storage device, a tool electrically coupled to the energy storage device, or both based on the comparison of the one or more metrics to the target threshold value; and transmit the one or more second metrics.

Example 3. The apparatus of Example 2, wherein the one or more second metrics comprise at least one of: an internal pressure value associated with the energy storage device; a temperature value associated with the energy storage device; an electrical shock value associated with the energy storage device; a vibration value associated with the energy storage device, the tool, or both; an acceleration value associated with the energy storage device, the tool, or both; a rotation speed value associated with the energy storage device; a bending value associated with the energy storage device.

Example 4. The apparatus of Example 1, wherein the instructions, when executed by the processor, further cause the processor to: provide power to circuitry comprised in the apparatus in association with transmitting the one or more metrics, based on the comparison of the one or more metrics to the target threshold value.

Example 5. The apparatus of Example 1, wherein the instructions, when executed by the processor, further cause the processor to: activate one or more functions based on at least one of: one or more control signals received at the apparatus; and the comparison of the one or more metrics to the target threshold value, wherein the one or more functions comprise at least one of: a first function associated with venting the energy storage device; and a second function associated with decoupling the energy storage device from a tool electrically coupled to the energy storage device.

Example 6. The apparatus of Example 1, wherein the one or more criteria comprise a detection of at least one of: a motion event associated with the energy storage device, a tool associated with the energy storage device, or both; a shock event associated with the energy storage device, the tool, or both; a rotation event associated with the energy storage device, the tool, or both; a bending event associated with the energy storage device, the tool, or both.

Example 7. The apparatus of Example 1, wherein the instructions, when executed by the processor, further cause the processor to at least one of: enter an active state associated with collecting the one or more metrics, based on the one or more criteria; and remain in the active state or enter a sleep state based on the comparison of the one or more metrics to the target threshold value.

Example 8. The apparatus of Example 1, wherein the instructions, when executed by the processor, further cause the processor to: establish a communication protocol socket associated with remotely connecting to the apparatus, wherein establishing the communication protocol socket is based on the comparison of the one or more metrics to the target threshold value.

Example 9. The apparatus of Example 1, wherein the instructions, when executed by the processor, further cause the processor to at least one of: transmit an alert notification based on the comparison of the one or more metrics to the target threshold value.

Example 10. The apparatus of Example 1, wherein the instructions, when executed by the processor, further cause the processor to: generate a data packet comprising the one or more metrics; and transmit the data packet.

Example 11. The apparatus of Example 1, wherein the noxious gas comprises one or more sulfur oxides.

Example 12. The apparatus of Example 1, wherein the noxious gas comprises sulfur dioxide.

Example 13. The apparatus of Example 1, wherein the one or more criteria comprise a temporal threshold.

Example 14. A system comprising: an energy storage device; a monitoring device configured to: collect one or more metrics associated with the energy storage device in response to one or more criteria, wherein the one or more metrics comprise a concentration level of a noxious gas; and transmit the one or more metrics based on a comparison of the one or more metrics to a target threshold value; and a computing device configured to generate one or more notifications based on the one or more metrics.

Example 15. The system of Example 14, further comprising a set of sensor devices configured to collect the one or more metrics, wherein the set of sensor devices comprise at least one of: a first sensor device configured to detect the noxious gas, measure a concentration level of the noxious gas, or both; a second sensor device configured to measure an internal pressure value associated with the energy storage device; a third sensor device configured to measure a temperature value associated with the energy storage device; a fourth sensor device configured to detect an electrical shock associated with the energy storage device; a fifth sensor device configured to measure a vibration amount associated with the energy storage device, a tool electrically coupled to the energy storage device, or both; a sixth sensor device configured to measure an acceleration amount associated with the energy storage device, the tool, or both; a seventh sensor device configured to measure a rotation amount associated with the energy storage device; and an eighth sensor device configured to measure a bending amount associated with the energy storage device.

Example 16. The system of Example 14, further comprising an access node configured to at least one of: relay the one or more metrics from the monitoring device and the computing device; and relay one or more control signals from the computing device to the monitoring device.

Example 17. A computer-implemented method comprising: collecting one or more metrics associated with an energy storage device in response to one or more criteria, wherein the one or more metrics comprise a concentration level of a noxious gas; and electronically transmitting the one or more metrics based on a comparison of the one or more metrics to a target threshold value.

Example 18. The computer-implemented method of Example 17, further comprising: collecting one or more second metrics associated with the energy storage device, a tool electrically coupled to the energy storage device, or both based on comparing the one or more metrics to the target threshold value; and electronically transmitting the one or more second metrics.

Example 19. The computer-implemented method of Example 17, further comprising: providing power in association with transmitting the one or more metrics, based on comparing the one or more metrics to the target threshold value.

Example 20. The computer-implemented method of Example 17, further comprising: activating one or more functions based on at least one of: one or more control signals; and the comparison of the one or more metrics to the target threshold value, wherein the one or more functions comprise at least one of: a first function associated with venting the energy storage device; and a second function associated with decoupling the energy storage device from a tool electrically coupled to the energy storage device.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/implementations in combination with any one or more other aspects/features/implementations.

Use of any one or more of the aspects or features as disclosed herein.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. An apparatus comprising:
a processor; and
a memory storing instructions thereon that, when executed by the processor, cause the processor to:
collect one or more metrics associated with an energy storage device in response to one or more criteria, wherein the one or more metrics comprise a concentration level of a noxious gas; and
transmit the one or more metrics based on a comparison of the one or more metrics to a target threshold value.

2. The apparatus of claim 1, wherein the instructions, when executed by the processor, further cause the processor to:
collect one or more second metrics associated with the energy storage device, a tool electrically coupled to the energy storage device, or both based on the comparison of the one or more metrics to the target threshold value; and
transmit the one or more second metrics.

3. The apparatus of claim 2, wherein the one or more second metrics comprise at least one of:
an internal pressure value associated with the energy storage device;
a temperature value associated with the energy storage device;
an electrical shock value associated with the energy storage device;
a vibration value associated with the energy storage device, the tool, or both;
an acceleration value associated with the energy storage device, the tool, or both;
a rotation speed value associated with the energy storage device;
a bending value associated with the energy storage device.

4. The apparatus of claim 1, wherein the instructions, when executed by the processor, further cause the processor to:
provide power to circuitry comprised in the apparatus in association with transmitting the one or more metrics, based on the comparison of the one or more metrics to the target threshold value.

5. The apparatus of claim 1, wherein the instructions, when executed by the processor, further cause the processor to:
activate one or more functions based on at least one of:
one or more control signals received at the apparatus; and
the comparison of the one or more metrics to the target threshold value,
wherein the one or more functions comprise at least one of:
a first function associated with venting the energy storage device; and
a second function associated with decoupling the energy storage device from a tool electrically coupled to the energy storage device.

6. The apparatus of claim 1, wherein the one or more criteria comprise a detection of at least one of:
a motion event associated with the energy storage device, a tool associated with the energy storage device, or both;
a shock event associated with the energy storage device, the tool, or both;
a rotation event associated with the energy storage device, the tool, or both;
a bending event associated with the energy storage device, the tool, or both.

7. The apparatus of claim 1, wherein the instructions, when executed by the processor, further cause the processor to at least one of:
enter an active state associated with collecting the one or more metrics, based on the one or more criteria; and
remain in the active state or enter a sleep state based on the comparison of the one or more metrics to the target threshold value.

8. The apparatus of claim 1, wherein the instructions, when executed by the processor, further cause the processor to:
establish a communication protocol socket associated with remotely connecting to the apparatus, wherein establishing the communication protocol socket is based on the comparison of the one or more metrics to the target threshold value.

9. The apparatus of claim 1, wherein the instructions, when executed by the processor, further cause the processor to at least one of:
transmit an alert notification based on the comparison of the one or more metrics to the target threshold value.

10. The apparatus of claim 1, wherein the instructions, when executed by the processor, further cause the processor to:
generate a data packet comprising the one or more metrics; and
transmit the data packet.

11. The apparatus of claim 1, wherein the noxious gas comprises one or more sulfur oxides.

12. The apparatus of claim 1, wherein the noxious gas comprises sulfur dioxide.

13. The apparatus of claim 1, wherein the one or more criteria comprise a temporal threshold.

14. A system comprising:
an energy storage device;
a monitoring device configured to:
collect one or more metrics associated with the energy storage device in response to one or more criteria, wherein the one or more metrics comprise a concentration level of a noxious gas; and
transmit the one or more metrics based on a comparison of the one or more metrics to a target threshold value; and
a computing device configured to generate one or more notifications based on the one or more metrics.

15. The system of claim 14, further comprising a set of sensor devices configured to collect the one or more metrics, wherein the set of sensor devices comprise at least one of:
a first sensor device configured to detect the noxious gas, measure a concentration level of the noxious gas, or both;
a second sensor device configured to measure an internal pressure value associated with the energy storage device;
a third sensor device configured to measure a temperature value associated with the energy storage device;
a fourth sensor device configured to detect an electrical shock associated with the energy storage device;
a fifth sensor device configured to measure a vibration amount associated with the energy storage device, a tool electrically coupled to the energy storage device, or both;
a sixth sensor device configured to measure an acceleration amount associated with the energy storage device, the tool, or both;
a seventh sensor device configured to measure a rotation amount associated with the energy storage device; and
an eighth sensor device configured to measure a bending amount associated with the energy storage device.

16. The system of claim 14, further comprising an access node configured to at least one of:
relay the one or more metrics from the monitoring device and the computing device; and
relay one or more control signals from the computing device to the monitoring device.

17. A computer-implemented method comprising:
collecting one or more metrics associated with an energy storage device in response to one or more criteria, wherein the one or more metrics comprise a concentration level of a noxious gas; and
electronically transmitting the one or more metrics based on a comparison of the one or more metrics to a target threshold value.

18. The computer-implemented method of claim 17, further comprising:
collecting one or more second metrics associated with the energy storage device, a tool electrically coupled to the energy storage device, or both based on comparing the one or more metrics to the target threshold value; and
electronically transmitting the one or more second metrics.

19. The computer-implemented method of claim 17, further comprising:
providing power in association with transmitting the one or more metrics, based on comparing the one or more metrics to the target threshold value.

20. The computer-implemented method of claim 17, further comprising:
activating one or more functions based on at least one of:
one or more control signals; and
the comparison of the one or more metrics to the target threshold value,
wherein the one or more functions comprise at least one of:
a first function associated with venting the energy storage device; and
a second function associated with decoupling the energy storage device from a tool electrically coupled to the energy storage device.
